(19) United States
(12) Patent Application Publication
(10) Pub. No.: US 2021/0081895 A1
(43) Pub. Date: Mar. 18, 2021

(54) SYSTEM AND METHOD FOR MATCHING BUSINESS WITH PARTNERS THROUGH A LOCATION AND SKILL BASED SUPPLY CHAIN COMPLIANCE

(71) Applicants: Andre Raghu, Boston, MA (US); Akshay Vazirani, Boston, MA (US)

(72) Inventors: Andre Raghu, Boston, MA (US); Akshay Vazirani, Boston, MA (US)

(73) Assignee: HIREAPARTNER, INC., Boston, MA (US)

(21) Appl. No.: 17/008,798

(22) Filed: Sep. 1, 2020

Related U.S. Application Data
(60) Provisional application No. 62/899,750, filed on Sep. 13, 2019.

(51) Int. Cl. G06Q 10/10; G06Q 30/00; G06Q 50/28; G06Q 30/06; G06Q 30/08; G06Q 50/18; G06Q 50/00; G06Q 10/02; G06Q 20/42; G06Q 10/06; G06N 20/00

(52) U.S. Cl. CPC G06Q 10/103; G06Q 30/016; G06Q 30/0185; G06Q 50/28; G06Q 30/0609; G06Q 30/0605; G06N 20/00; G06Q 50/188; G06Q 50/01; G06Q 10/02; G06Q 20/42; G06Q 10/06395; G06Q 10/105; G06Q 30/08

(57) ABSTRACT

The present invention provides a digital matching platform for connecting and bounding customers into the smart contract globally with location and supply based vetted/qualified supply chain compliance service providers, where the customer includes brands, retailers, importers and manufacturers, the service provider includes auditors, inspectors, consultants, verifiers, certification and testing companies for the purpose of verifying compliances including test reports, audits and assessments, corrective action and remediation, capacity building and improvement factory evaluation, factory improvement, seminars, training, product inspection, ethical, environmental, food and security supply chain audits at production, manufacturing, warehouse, retail and service center sites across the global supply chain. The digital matching platform allows customer and service providers to register within the platform using their personal and professional details, verifies the details and checks authenticity of service providers, allows customer to create project/assignment of desired service within the platform and allows the customer and service provider to connect and build a contract for completion of service required by the customer. The digital platform includes a location and skill set matching component that matches and connects customer with best suited service provider based on location and skill set.

### FIELD OF THE INVENTION

The present invention relates to the online business to business matching platform for location and skill-based supply chain compliance. More particularly, the present invention relates to the system, method and an AI & Block chain-enabled platform that allows customers to globally connect and bound into a smart contract with the vetted/qualified supply chain compliance service providers.

### BACKGROUND OF THE INVENTION

The traditional process of outsourcing supply chain compliance factory audits, inspections, certifications and consulting services to third party service providers and procuring services is highly fragmented, time consuming and too expensive. A buyer of supply chain compliance factory audit, inspection, certification and consulting services has traditionally located auditors or inspectors and consultants through third-party auditing, testing, inspection and certification service providers. Once a service provider is located, the buyer has to contact the business, arrange a method or time to review the business prior work or otherwise evaluate business qualifications for the project and negotiate an audit, inspection or consulting service fee. Even in the age of the Internet, thousands of service providers, both individuals and companies, offer their services, but most are off-line and if on-line, their individual web sites or online postings are often difficult to find or do not disclose sufficient information regarding the quality of their work product, reputation or availability. In addition, a buyer of services still has no visibility nor insight to the third-party service providers such as factory auditors, inspectors or consultants on an individual basis to objectively and effectively assess skills and competencies of the individual and firm, ensure skills and qualification matching against compliance needs, negotiate specifications, availability, price, review historical performance track record or rate performance upon completion of services.

The process of managing outsourced supply chain compliance such as factory audits, inspections, certifications, consulting projects and collaboration with service providers has also been highly inefficient and filled with negative effects. As a result, comparison-shopping, negotiation, collaboration and managing quality and integrity concerns with service providers have traditionally been time-consuming, inefficient, ineffective, and costly for global traders buying services. There is no platform providing robust processes and systems which may enhance credibility and value to the supply chain compliance industry by maintaining current and accurate information.

For larger entities, such as multi-national organizations, whose factories represent a substantial majority of the global trade industry, in the digital and omni channel era, it is more important than ever to increase the value and effectiveness of supply chain compliance such as factory audits, inspections, certifications and consulting. The method and protocols must at the same time enhance the professionalism, consistency and credibility of individual supply chain factory auditors, inspectors and consultants performing assignments. A large corporation may outsource thousands of supply chain compliance services such as factory audits, inspection, certifications and consulting assignments annually, each with a substantial purchase price and risk management goal. The administrative overhead alone for procuring and managing the services is a considerable financial burden. Engaging an unqualified, unprofessional, or corrupt factory auditor, inspector or consultant is a substantial brand risk. Today, buyers of factory compliance services have no method to objectively and effectively ensure the skills and competencies of individual supply chain compliance service providers such as factory auditors, inspectors or consultants. Also. There is not any method available to match each project request or to measure and enhance the professionalism, consistency and credibility of the individuals and organizations performing the work.

The nature of the supply chain compliance services including factory audit, inspection and consulting business is changing. The management, procurement and delivery of services are becoming decentralized as global traders increasingly outsource for their needs and seek a new digitized supply chain model. The need for a new factory compliance industry model is growing as consumers develop greater supply-chain awareness through peak global connectivity. New kinds of business organizations are emerging as employees seek greater flexibility through working independently. Large, vertically integrated Testing, Inspection and Certification (TIC) companies are being replaced by smart economy contingent or alternative workforces of in country pre-screened, self-managed, highly skilled supply chain factory compliance professionals who form online contracts, engage in a skill matching protocol, complete a factory audit or inspection task and disband after the project completion. In this new smart economy, there is a strong need for infrastructure that can facilitate global traders to find, hire, work with, monitor and pay highly skilled supply chain compliance se c providers such as factory auditors, inspectors and consultants in a trusted marketplace efficiently.

Further, in this smart economy, the available infrastructure fails to facilitate global traders and customers to connect with the skill set and location-based supply chain compliance individual or firm of service providers. The available infrastructure fails to allow the global traders or customers to find the best suited supply chain compliance service provider that fulfills each and every requirement of skill set for the service, location, timing, experience and expertise for the service so both the businesses global traders (customer) and the skilled service providers (individual/firm) may establish life-long business relationship for exchange of supply chain compliance service. The currently available infrastructure allows direct registration of the traders or customers and factory supply chain compliance service provider without conducting an in-depth interview or even without verification of correctness of details and/or cross checking the expertise submitted by the service providers, hence even unskilled service providers get a membership, which in turn increases traffic on these other platforms. Moreover, there is not any infrastructure or platform available that exactly matches each and every skill requirement as well as the location requirement of the global trader's with the skill set of the supply chain compliance service providers, or that selects the service provider who fulfills each and every requirement and inform that precisely selected skilled service providers about the supply chain compliance service requirement of the global trader so that they may connect and create a smart contract for the supply chain compliance service and also work as a partner to make a life-long business relationship.

Therefore, there exists a need of a way to continue the concept of procurement solutions which connects individual buyers within a corporation and service vendors, using cloud and online services both block chain and skill/talent-based protocols so that the services offered by various individual/firm of supply chain compliance auditors, inspectors and consultants can be implemented at a lower cost with a higher level of quality and integrity governance. Further, there exists a need of a platform that may connect global traders and businesses with the precisely selected, best suited skilled supply chain compliance service providers to work as a partner to the business and establish life-long business relation. Further, there exists a need of a system that may allow very selected skilled supply chain compliance service providers to access the platform, and that only after precise verification of each and every detail (personal and professional) and interview of the service provider thus increasing chances of the global traders and customers to connect the best supply chain compliance service provider for their required service.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The subject matter of present invention provides a computer implemented system and a platform. to connect customers including brands, retailers, importers and manufacturers with vetted/qualified supply chain compliance service providers like auditors, inspectors, consultants, verifiers, certification and testing companies for the purpose of verifying supply chain compliance, where the supply chain compliance includes: test reports, audits and assessments, corrective actions and remediation, capacity building and improvement, factory evaluation, factory improvement, seminars, training, sustainability, product inspection, ethical, environmental, food and security supply chain audits at production, manufacturing, warehouse, retail and service center sites across the global supply chain.

According to one embodiment, the system allows building of smart contract between customer and skilled service provider/firm of service provider. The system and computer implemented digital platform includes a location and skill set matching component to match the required skill, experience and location of the individual/firm of service provider for the project with the skill set, location and experience of all the verified service providers registered within the platform, and based on the results it suggests the project to the best suited service providers who fulfills all the requirements of the project. Also, it allows that best suited service providers to bid on that project. The location and skill set matching component of the digital platform, based on the job description and service requirement of the customer, creates a digital workspace with all the details of customer and his/her requirement. The location and skill set matching component further compares the location and skill set requirement for the work with the skill set and location of vetted/qualified supply chain compliance service providers, registered within the system; and based on the matching results, notifies one or more best suited service provider for the work and allows that service providers to access the digital workspace to bid, negotiate and complete the required work.

According to one embodiment, the system provides a digital platform for customers across the globe to access the platform by registering within the platform using his/her personal as well as company details along with the description of required work or service. It provides a platform for vetted/qualified service providers to access the platform by registering within the platform using his/her personal details as well as company details, area of expertise, years of experience, preferred location of work etc.. The system verifies the authenticity of the service providers sing various tools, such as cross-verification and cross-linking with social media account, verification through other identity proofs such as driving license, passport or other government issued identity proof. Further, to check correctness or expertise and work experience, the system seeks certification documents of the service provider and allows the owners or administrators of the platform to interview the candidate who is willing to register as a service provider, before allowing registration of the service provider within the platform.

After registration as a customer within the system and after filling the details of service required, the system creates a workspace within the platform with all the details of required work and details of customer; compares the required experience, expertise and location for the work with the experience, expertise and location of registered service providers within the system; and notifies one or more best suited service providers for the work. Further, the platform allows selected service providers to access the created workspace, bid for the work, send proposal to the customer in the workspace, communicate and negotiate with customer, update status report of the work and generate invoice for the work after completion of work. The system produces strong network effects designed to establish industry credibility and position of supply chain compliance service providers including factory auditors, inspectors, consultants or service providers.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates flow diagram showing stepwise flow of work to connect customer with the vetted supply chain compliance service provider within the digital platform of present invention.

FIG. 2 illustrates schematic diagram showing process of registration of customer within the platform of present invention.

FIG. 3 illustrates schematic diagram showing process of registration of vetted/qualified supply chain compliance service providers within the digital platform of present invention.

FIG. 4 illustrates schematic diagram showing process of authentication/KYP of service provider during initial registration of service provider within the digital platform of present invention.

FIG. 5 illustrates schematic showing stepwise process of creation of project or assignment of work required by the customer over the digital platform.

FIG. 6 illustrates schematic of service provider dashboard within the digital platform of present invention.

FIG. 7 illustrates schematic showing stepwise process of submission of proposal by the service provider for the project.

### DETAILED DESCRIPTION OF INVENTION

The present invention overcomes the aforesaid drawbacks of the above, and other objects, features and advantages of the present invention will now be described in greater detail. Also, the following description includes various specific details and are to be regarded as merely exemplary. Accordingly, those of ordinary skill in the art will recognize that: without departing from the scope and spirit of the present disclosure and its various embodiments there may be any number of changes and modifications described herein.

The computer implemented system, method and digital matching platform of present invention provides a digital platform for connecting and bounding customers like brands, retailers, importers and manufacturers globally with the vetted/ qualified supply chain compliance service providers such as auditors, inspectors, consultants, verifiers, certification and testing companies into the smart contract for the purpose of verifying compliance including: test reports, audits and assessments, corrective action and remediation, capacity building and improvement, factory evaluation, factory improvement, seminars, training, product inspection, ethical, environmental, food and security supply chain audits at production, manufacturing, warehouse, retail and service center sites across the global supply chain.

The digital platform of present invention includes a location and skill set matching component that compares and matches the required location and skill set for the project/assignment with the location and skill set of the service providers registered within the digital platform, determines the best suited service provider for the required service using the machine learning algorithm/AI of the computer implemented system, and connects that best suited service provider with the customer for the project/assignment. The digital platform of present invention automatically creates workspace with the creation of project/assignment of work by the customer, where the workspace serves as a workroom for the selected service provider to create smart contract with the customer, bid on the project of customer, send quotes and proposals for the project and to communicate with the customer during and after completion of project. Also, the workspace allows customer as well as owners/administrators of the platform to monitor the status report of day to day progress of the projected work completed by the service provider. Further, the digital platform includes monitoring component that allows owners of the platforms to monitor thee platform and release the payment after approval of payment from the customer and based on successful outcome of project/assignment and completion of the assignment/project by the service provider.

According to one embodiment, the method of working of the digital platform of present invention includes allowing registration of customers and service providers using their personal details and credentials, authenticates the person by verifying the provided details and then allows connection between the customers and the service providers. The digital platform of present invention allows customer to create a project/assignment for the service or work the customer seeks, by submitting all the information such as type of required service, location of service, required expertise and qualification of service provider etc. With creation of project by the customer, the digital platform of present invention creates a workspace with all the details, compares the details of requirement of location and skill set with the detail of registered service providers within the digital platform, and notifies about the project/assignment to one or more best suited service providers for the project. Wherein workspace allows service providers to send proposals and quotation for project, negotiate with the customer, communicate with customer, upload progress report and also allows to receive payment for the service.

According to one embodiment, the method of working of the system and digital platform of present invention also includes allowing the individuals representing firms of service providers to register within the platform using personal details, complete details of firm which the service provider is representing with all the specific details such as the services they provide, industries in which the service provider provides service and sub-type of services, type of assessment looking to perform or more specific information about their service. Further, the system and digital platform of the present invention asks for the detail of distance the service provider is willing to travel using ground travel or using air if airfare is given, years of experience in this field, area of expertise etc. The method of working of the system and digital platform of present invention further includes allowing the owners of the platform to scrutinize all the details of service provider and generate inquiry for service provider if there is any confusion or too many grammatical mistakes in details provided by the service providers, before allowing his/her firm or individual service provider to get registration into the platform. Further, the system and platform of present invention allows the owners of the platform to interview the candidate who is willing to register as a service provider using video conference or in person, before registration as a service provider.

Hence, the system and digital platform of present invention matches very precise details of service provider with the required service by the customer in project, thus connects best suited service provider to establish life-long business relation between customer and service provider. The system and digital platform of the present invention eliminates extra time and efforts of customer in fetching most appropriate service provider from the long list of suggestion in conventional platform and eliminate manual comparing the required skills with the skills of suggested long list of service providers and contacting too many service providers to select best one. Instead, the present system and digital platform seeks too exact and technical details on the expertise and location requirement for the project and compares it with the skills of the registered service providers using the machine learning algorithm or AI of the system and suggests the project only to the service providers who fulfills all the requirement for the service mentioned in the project.

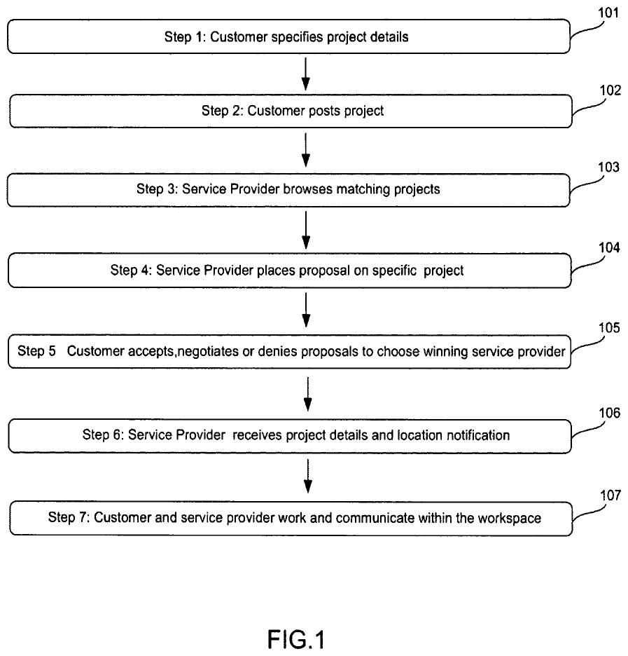

Referring to FIG. 1 which exemplarily illustrates flow diagram showing stepwise flow of work to connect customer with the vetted supply chain compliance service provider within the digital platform of present invention. The steps to connect the vetted supply chain compliance service provider with the customer using the digital platform of present invention includes steps such as: a digital platform allows customer to specify project details within the digital platform 101; the digital platform allows customer to posts a project within the platform 102; the digital platform allows registered and authenticated service providers to browse matching projects based on their expertise and location 103; the digital platform allows service providers to place proposals and bid on specific projects 104; the digital platform allows customer to accept, negotiate or deny proposals to choose winning service provider 105; the digital platform notifies the service provider with the project details and location 106; the digital platform creates a workspace for customer and service provider to bound under the smart contract for the project and to work and communicate within the workspace during project 107.

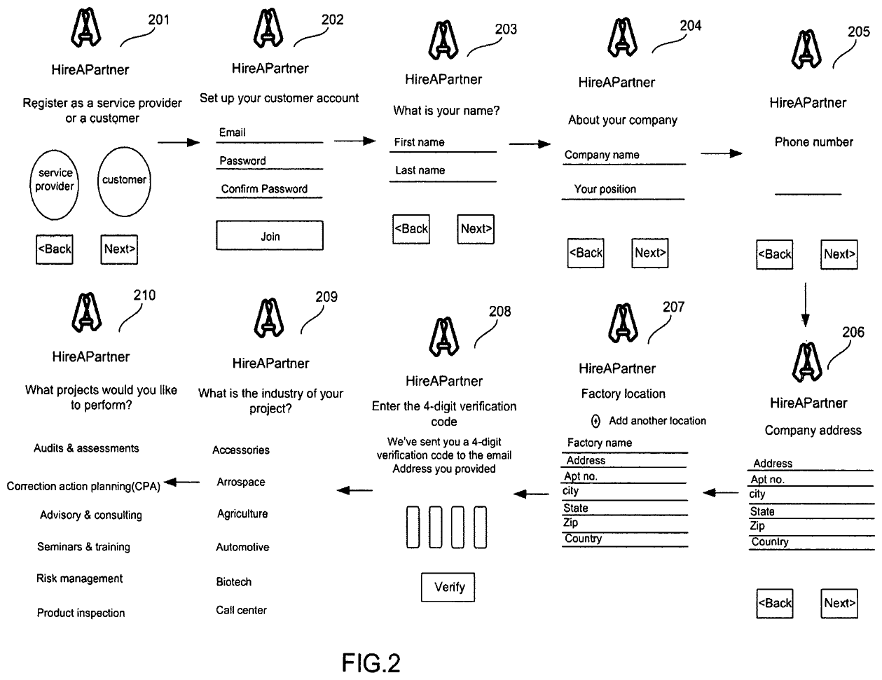

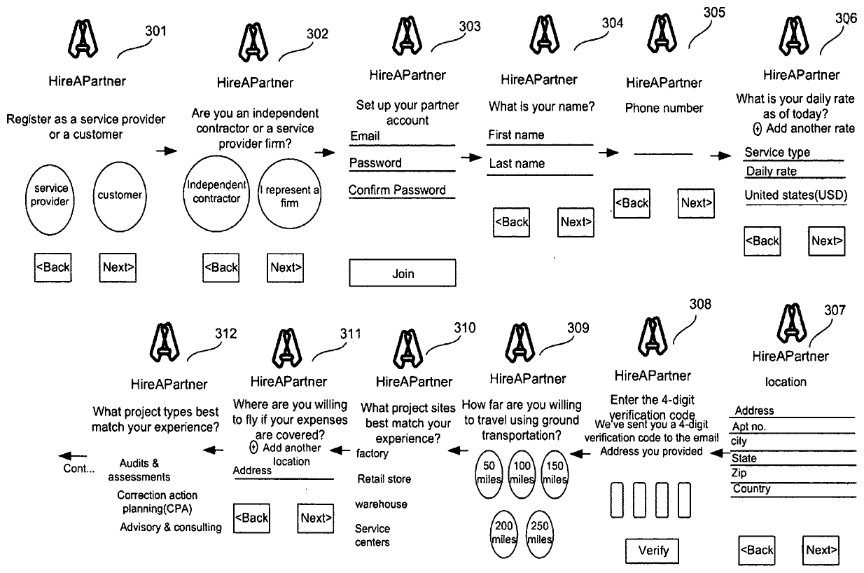

FIG. 2 exemplarily illustrates schematic diagram showing process of registration of customer within the computer implemented digital platform of present invention. The digital platform of present invention allows customers including brands, retailers, importers and manufacturers to access the digital platform to connect with the vetted/qualified supply chain compliance service providers based on location and skill set. The dashboard of the customer for registration within the digital platform requires stepwise information as: register as a service provider or a customer 201; set up customer account using personal email address and password 202; provide personal details such as name 203; provide company name 204; provide phone number 205; provide company address 206 and factory location 207; verify verification code received from the digital platform on the registered mobile number of customer 208; relevant industry of customer's project 209; information regarding the projects the customer would like to be performed by the service provider 210. After providing all the details of all these steps only, the customer gets registration within the digital platform and the computer implemented system determines best suited service provider according to the requirements of the customer using the machine learning algorithm or AI of the system, notifies the details with profile of the selected service provider to the customer, and creates workspace for the customer and the service providers to discuss the project, negotiate, communicate and bound under the smart contract within the digital platform of present computer implemented system.

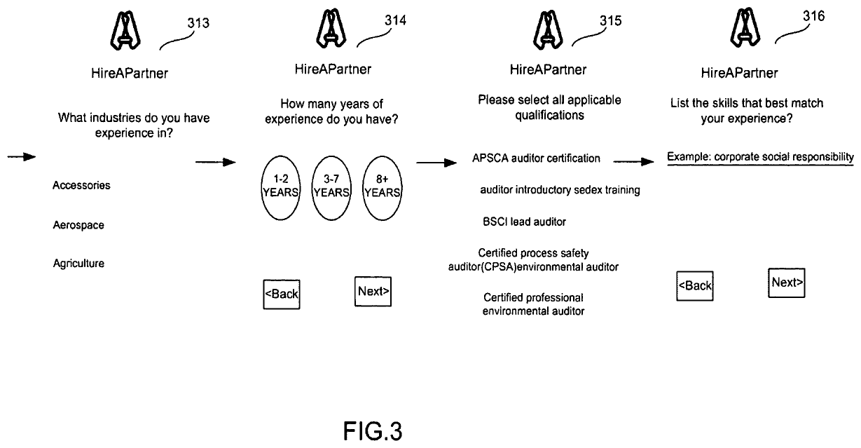

Now referring to FIG. 3 which illustrates schematic diagram showing process of registration of vetted/qualified supply chain compliance service providers within the digital platform of present invention, where the registration of service provider includes some extra steps and information than the registration of customer and the reason for that is to verify authenticity of service providers being registered within the digital platform of present invention. The dashboard of the service provider for registration within the digital platform requires stepwise information in steps as: select to register as a service provider or a customer 301; provide details whether the service provider is independent contractor or a service providing firm 302; set up a partner account using email address and password 303; provide personal details such as name 304; phone number 305; information of daily rate of service provider 306; location of service provider 307; verification using verification code received by the service provider from digital platform 308; details of distance the service provider is willing to travel using ground transportation 309; information of project site that best matches service provider's experience 310; information regarding places the service provider is willing to fly if expenses are covered 311; information of project type that best matches service provider's experience 312; details of experience of service provider in different industries 313; years of experience 314; details of qualification of service provider 315; and the skill set of the service provider that best match his/her experience 316.

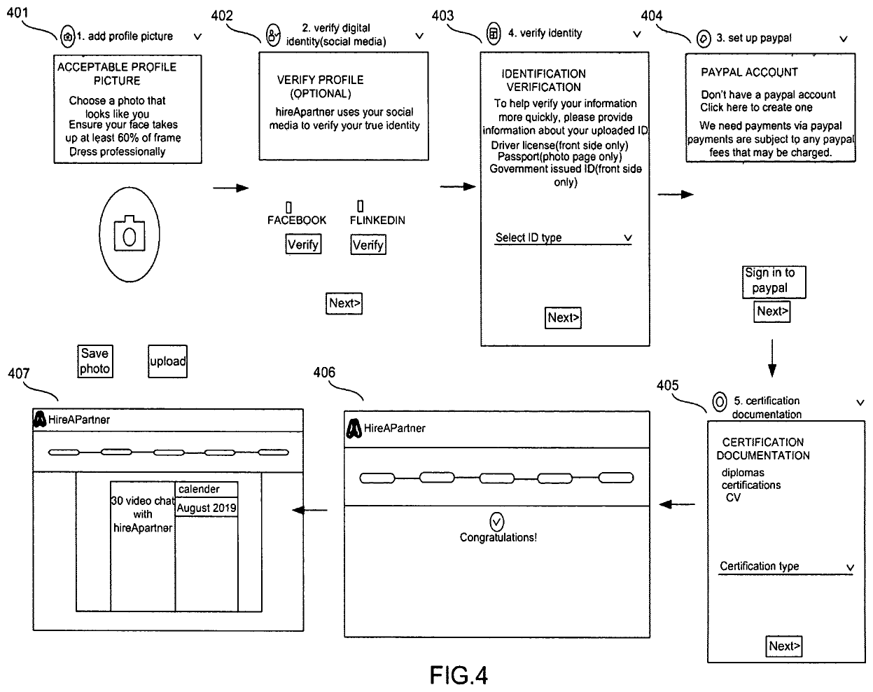

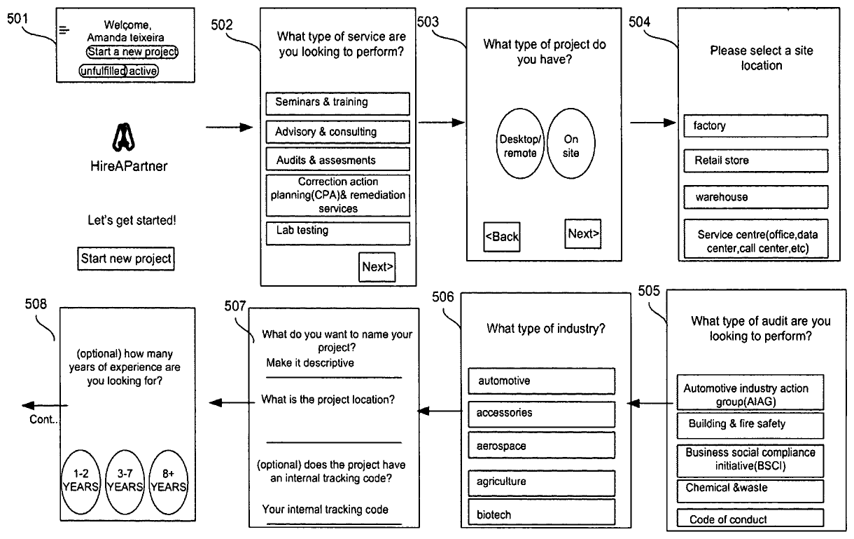

After completion of steps of FIG. 3, the digital platform seeks some more details for authentication and verification of service provider. For instance, FIG. 4 discloses schematic diagram showing process of authentication/KYP of service provider during initial registration of service provider, where the process of authentication includes steps of: requiring profile picture of service provider 401; verifying digital identity or linking the platform account with social media account of service 402; verifying identity by verification of any of the driving license, passport or government issued ID 403; setting a payment account of the service provider 404; requiring qualification certificates of service providers 405; completing process of information requirement from the service provider 406; and verifying the service provider by having a video communication with the service provider 407.

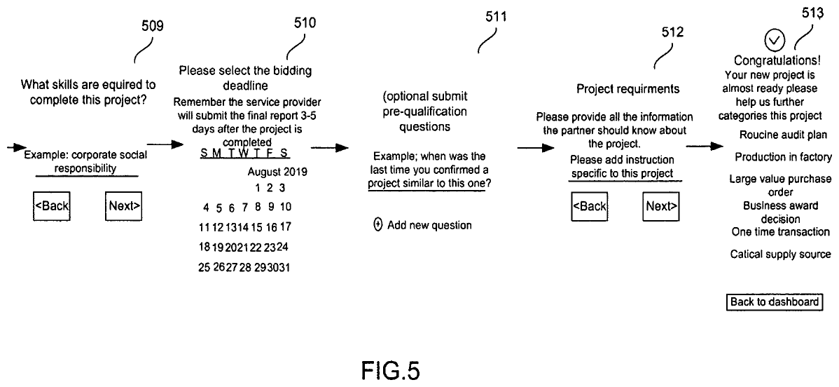

Now, FIG. 5 illustrates schematic showing stepwise process of creation of project or assignment of work required by the customer over the digital platform of present invention, where the digital platform requires details and steps as: select start new project 501; select type of service the customer is looking to perform 502; select the type of project such as desktop or remote or onsite 503; select the site location 504; select the type of audit the customer is looking to perform 505; select the type of industry 506; other details such as name of project etc. 507; select the years of experience the customer is looking for 508; provide details of the required skill for the project 509; select the bidding deadline 510 submit pre-qualification questions 511; and provide all the information the service provider should know about the project 512 that completes the creation of new project by showing flag of congratulations 513.

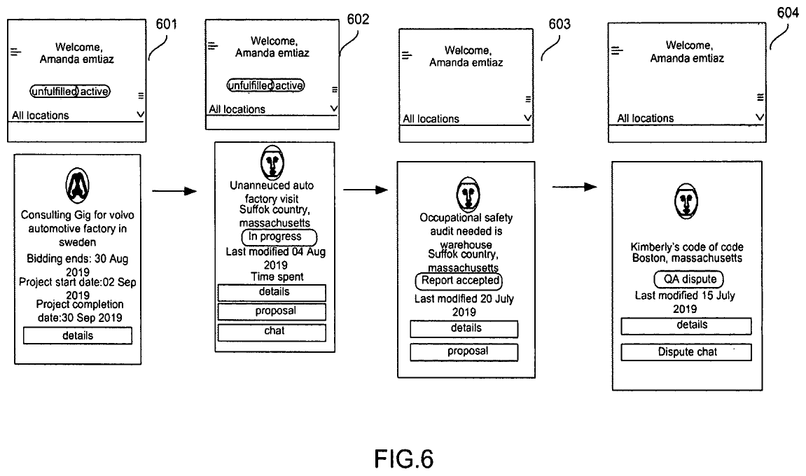

FIG. 6 discloses schematic of service provider dashboard within the digital platform of present invention, where the dashboard displays details of all the project relevant to respective service provide which includes list of new projects 601; projects which are under process 602; projects which are completed by the service provider 603; and the projects where the proposals were sent by the service provider but not accepted by the customer, or where dispute happened between service provider and customer 604.

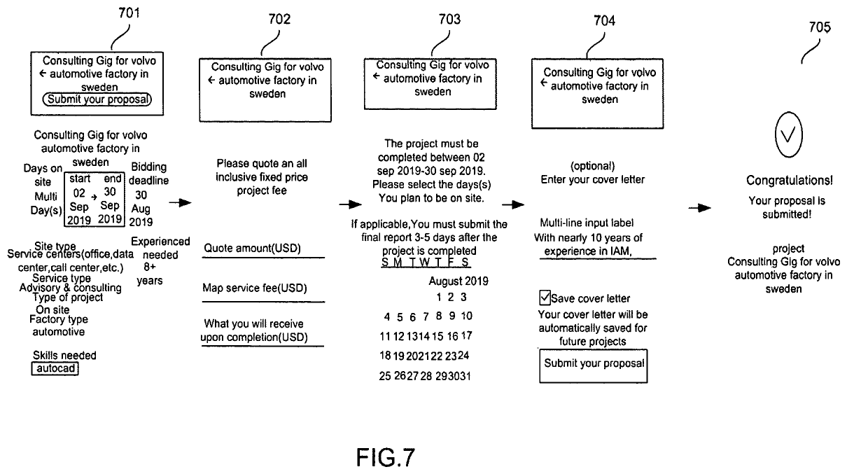

Further, FIG. 7 illustrates schematic showing stepwise process of submission of proposal by the service provider for the project within the workspace created by the digital platform of present invention. Where the digital platform allows the service provider to: consult the customer 701; quote the customer with all the fixed price project fee 702; provide the details of estimated duration required for the project 703; and submit the cover letter 704, that completes the process of bidding for the project showing a congratulation flag 705.

According to one embodiment, the present computer implemented system further monitors safety of the vetted or skilled supply chain compliance service providers by allowing the service provider to upload a real time images or video from the project location of the customer over the digital platform where an AI or machine learning algorithm of the platform analyzes the surrounding environment of the service provider to detect any hazard. For instance, the digital platform of present invention detects the workers without required personal protective equipment (PPE) within the surrounding environment of the service provider and accordingly rates the customer for reference of future tasks of the same customer.

According to one another embodiment, the computer implemented system of present invention uses specially designed drones or the cameras already located at the location of the customer where the supply chain compliance service is required to feed the digital platform with the detail of real time surrounding environment at the location to analyze and detect any possible hazard for the service provider using the artificial intelligence present within the platform and notifies the service provider as well as the customer about the hazard also prepare a report and stores on the platform. The computer implemented system of present invention monitors the complete facility or location of the customer where the compliance service is needed using the feed from the drones of the system, existing cameras fixed at the location or from the images or videos uploaded by the service providers once reaching at the location.

The foregoing description of the specific embodiments still so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for connecting a customer with a qualified service provider, the system comprising:
a computing system comprising of a processor, a storage and a communication interface coupled to a network,
wherein the computing system creates a digital platform comprising an AI powered location and skill set matching platform; at least one workspace and a monitoring component, that allows connection between the customers and qualified service providers for a supply chain compliance services;
wherein the digital platform allows the customers to access the digital platform by registering within the digital platform using precise personal details, details and location of the company the customer representing and a purpose of registration;
wherein the digital platform allows the service provider to access the digital platform by registering within the digital platform using precise personal details, details of service pilling to provide, years of experience; details of types of industries in which the service provider provides service, type of assessment looking to perform, and details of distance the service provider is willing to travel using ground travel car air travel,
wherein the digital platform allows an owner or administrator of the digital platform to scrutinize details of the service providers, verify the authenticity and correctness of the details, and interview the customer using the digital platform;
wherein the digital platform further allows customer to create a project or assignment within the digital platform by submitting precise details of required service, skill set and location for that required service;
wherein the AI powered location and skill set matching component of the digital platform matches the required location and skill set for the project or assignment with the location and skill set of all the registered service providers of the digital platform to identify a best suited service provider for the project who fulfills each and every requirement mentioned by the customer in the project or assignment; and
wherein the digital platform notifies the customer with the details of the selected best suited service provider for the project or assignment and connects the customer with the best suited service provider over the digital platform.

2. The system of claim 1, wherein the digital platform of the computing system creates at least one workspace with creation of each new project or assignment that allows one or more selected and best suited service provider to create a smart contract with the customer, bid on the project, communicate and negotiate with the customer, submit status report and generate invoice for the service.

3. The system of claim 1, wherein the monitoring component allows an owner or administrator of the digital platform to monitor the digital platform and release a payment after approval of payment from the customer and based on successful outcome of project or assignment and completion of the assignment or project by the service provider.

4. The system of claim 1, wherein the supply chain compliance services includes test reports, audits and assessments, corrective action and remediation, capacity building and improvement, factory evaluation, factory improvement, seminars, training, product inspection, ethical, environmental, and food and security supply chain audits at production, manufacturing, warehouse, retail and service center sites.

5. The system of claim 1, wherein the detail of required skill set of the service provider includes details of years of experience of the service provider, details of last time performed the same service, details of issues and concerns related an industry of the service, and details of industry where performed the last service.

6. The system of claim 1, wherein the digital platform while creating a project or assignment further requires the customer to select the deadline for bidding, mention duration and date for required service, location of required service and number of required days on site.

7. The system of claim 1, wherein the system further monitors safety of the service provider at a service location by allowing service provider to send real time images or videos from the service location, where the Artificial Intelligence of the digital platform analyzes the images or videos to detect the possible hazard.

8. The system of claim 1, wherein the AI of the system further detects a workers or individuals without required personal protective equipment (PPE) surrounding the service provider using the images or videos received from the service provider and informs the same to the customer as a report.
